(19) United States
(12) Patent Application Publication
(10) Pub. No.: US 2010/0025188 A1
(43) Pub. Date: Feb. 4, 2010

(54) PROCESS AND DEVICE FOR PICKING UP, TRANSFERRING AND HANDLING PLASTIC CONTAINER PREFORMS

(75) Inventor: Lino Lanfranchi, Collecchio (FR)

Correspondence Address: YOUNG & THOMPSON, 209 Madison Street, Suite 500, Alexandria, VA, 22314, US

(73) Assignee: LANFRANCHI S.R.L., Collecchio (PR) (IT)

(21) Appl. No.: 12/443,296

(22) PCT Filed: Nov. 23, 2007
(86) PCT No.: PCT/EP07/62776

§ 371 Date: Mar. 27, 2009

(30) Foreign Application Priority Data
Nov. 28, 2006 (IT) PR2006A000106

(51) Int. Cl. B65G 47/24; B29C 49/00; B65G 47/248

(52) U.S. Cl. 198/377.08; 425/534; 198/377.01; 198/377.07

(57) ABSTRACT

A process and a device for picking up, transferring and handling plastic container preforms molded by a special molding machine, wherein gripper pick up and transfers the preforms from the mold or from an ejector to a conveyor device. The preforms are deposited and carried on the conveyor in a standing position. The conveyor device (2) holds the preform in a stable position during handling.

The present invention relates to a process for picking up, transferring and handling plastic container preforms.

The present invention further relates to gripper and conveyor devices for picking up, transferring and handling said preforms molded or anyway formed by a special forming machine.

Typically, as the molds of the machine are opened, these preforms fall in bulk onto a belt conveyor, which carries them to a container where they are collected in bulk.

The present invention has the object of providing a process and a system or device that allows orderly handling of rows of preforms, for further improved processing of such preforms, i.e. for orderly storage thereof in said plastic containers, or for direct transfer thereof to a blow molding line (although this usually occurs in a different factory, and hence preforms need to be stored).

These objects and advantages are achieved by the process and devices for picking up, transferring and handling said molded preforms according to the present invention, which are characterized by the annexed claims.

These and other features will be more apparent from the following description of a few embodiments, which are shown by way of example and without limitation in the accompanying drawings, in which:

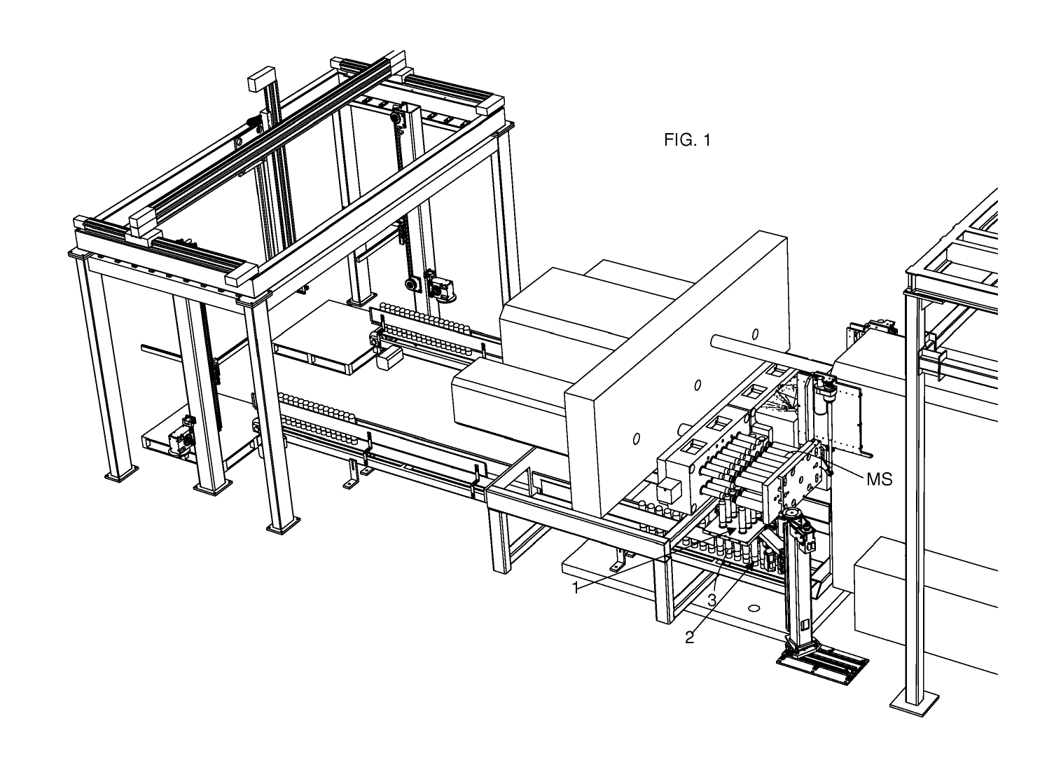

FIG. 1 is a general view of a machine for molding and unscrambling plastic preforms according to the process of the present invention,

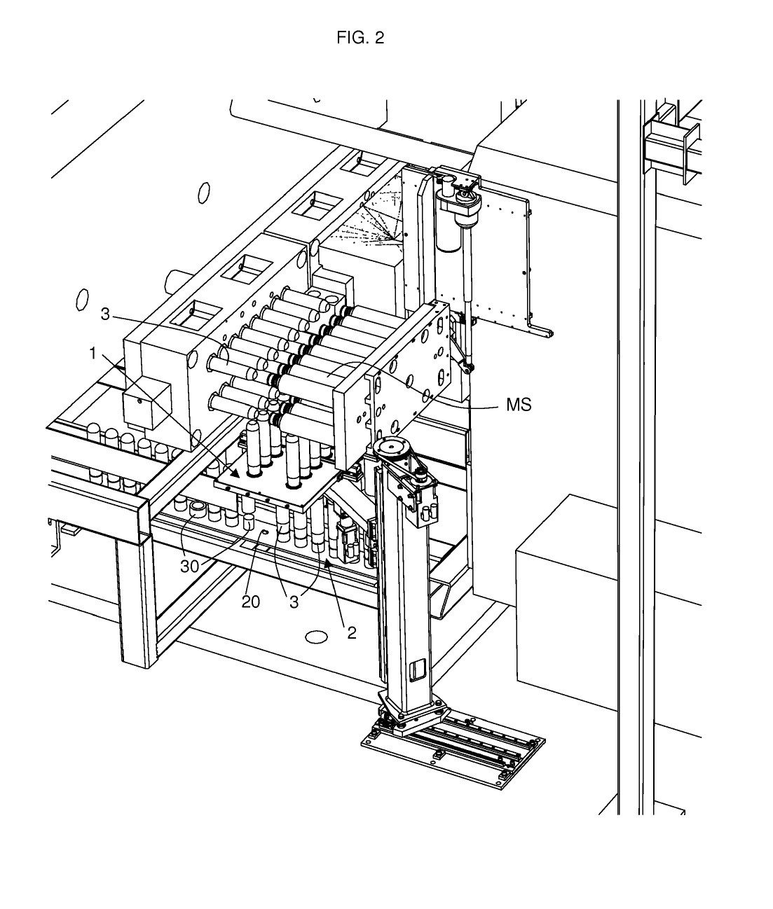

FIG. 2 shows a detail of area in which the preforms are picked up and transferred to a conveyor device, which is also addressed by the invention,

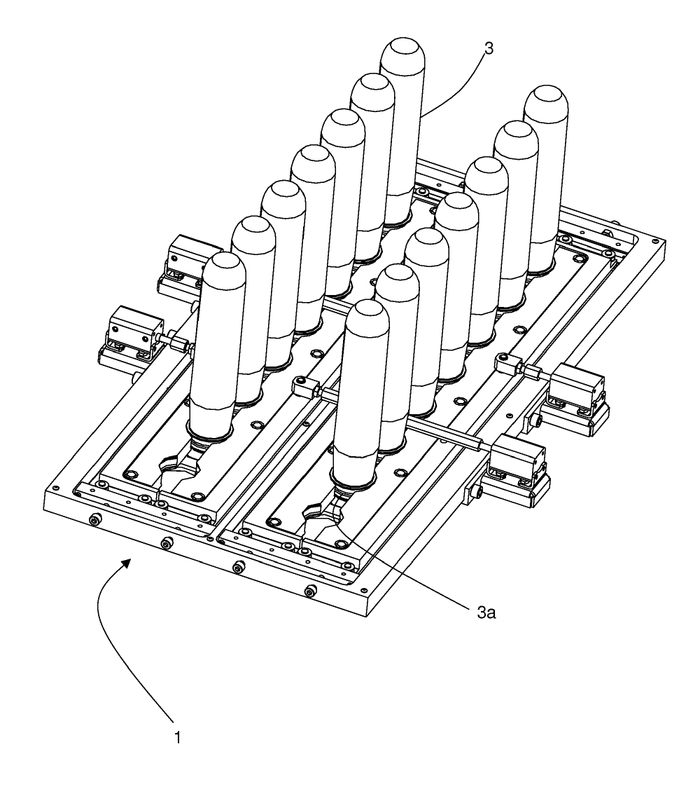

FIG. 3 shows a detail of the preform gripper means according to the invention,

FIG. 4 shows an arrangement including means for stabilizing the preform on the conveyor.

Referring to FIGS. 1 and 2, numerals 1 and 2 designate two devices for picking up, transferring and handling plastic container preforms 3 molded by a special molding machine 4; in greater detail, these devices include at least one gripper means 1 for picking up and transferring said preforms 3 from the mold or from ejection means MS onto a conveyor device 2, namely a belt conveyor; it shall be noted that the preforms 3 are placed on said conveyor device 2 in a standing position.

With further reference to FIG. 3, it will be noted that the gripper means 1 grip the preforms 3 at their open end 3a; furthermore, these means are movable and can rotate or translate along multiple handling axes.

Preforms are preferably gripped from ejection means MS, which are also used for allowing the preforms to cool.

These ejection means MS include a plurality of bushings or cylinders, each adapted to receive a preform 3; by actuating vacuum, the ejection means MS hold the preforms 3 thereon and can take a vertical position to release them to the underlying head 1 which transfers them to the conveyor device 2 as disclosed and claimed herein.

The preforms 3 may stand on the device 2 in an unconstrained manner or the conveyor device 2 may have means for holding preforms in stable positions during handling, including suction means operating through suitable perforations 20 in the conveyor device 2 at the preform deposit area and underlying suction assemblies, designated as AS.

Also, the means for stabilizing the preform 3 may include inverter motors (not shown) which are adapted to drive the conveyor device 2 in such a manner as to ensure low acceleration or deceleration values for the conveyor device.

According to a further illustrated variant embodiment, said means for stabilizing the preform in a standing position are pins 30 that extend vertically from the conveyor device 2 and can be mounted into or onto the overlying preforms 3; the pins may be fixed or vertically retractable under the conveyor device 2 for preform accumulation; also, for the same reason, the pins may be driven by further drive means, other than the preform conveyor device but parallel to them.

Therefore, the process that can be carried out by the device as described above includes the step of picking up and transferring said preforms from the mold or the ejection means, using at least one gripper means 1 which grips said preforms at their open end.

Then, the process includes the step of depositing the preforms on a conveyor device 2 and carrying them in a standing position on said conveyor device.

Also, the step is provided of holding and feeding the preform in such stable standing position by means of suction systems that operate through suitable perforations of the conveyor device at the preform deposit area, using inverter motors or coupling pins which extend vertically from the conveyor means.

1. A process for picking up, transferring and handling plastic container preforms (3) molded by a special molding machine, characterized in that it includes the step of handling said molded preforms (3) on a conveyor device (2), said preforms being placed in a standing position on said conveyor device (2).

2. A process as claimed in claim 1, characterized in that it includes the step of holding and feeding the preform in such stable standing position by means of suction systems that operate through suitable perforations (20) of the conveyor device at the preform (3) deposit area.

3. A process as claimed in claim 1, characterized in that the preform is stably fed in said standing position by means of inverter motors.

4. A process as claimed in claim 1, characterized in that it includes the step of holding and feeding the preform in such stable standing position by means of mounting pins (30) that extend vertically from the conveyor device; said pins (30) being mounted either into or onto said preforms.

5. A process as claimed in claim 1, characterized in that said conveyor device is at least one belt conveyor.

6. A process for picking up, transferring and handling plastic container preforms molded by a special molding machine, characterized in that it includes the step of picking up and transferring said preforms from ejection means (MS) using at least one gripper means (1).

7. A process as claimed in claim 6, characterized in that it includes the steps of gripping said preforms (3) from said ejection means (MS) at their open end (3a); said means (MS) being provided with a system for holding the preforms (3).

8. A process as claimed in claim 6, characterized in that the molded preforms are deposited on a conveyor device (2) in a standing position.

9. A device (1, 2) for picking up, transferring and handling plastic container preforms (3) molded by a special molding machine, characterized in that it comprises gripper means (1) for picking up and transferring said preforms from the mold or from ejection means (MS) to a conveyor device (2), said preforms being placed and carried in a standing position on said conveyor device (2).

10. A device as claimed in claim 9, characterized in that said gripper means (1) grip the preforms at their open end (3a).

11. A device as claimed in claim 9, characterized in that said gripper means (25) are movable and can rotate or translate along multiple handling axes.

12. A device as claimed in claim 9, characterized in that the preforms (3) stand on the conveyor device (2) in an unconstrained manner or the conveyor device (2) has means for holding the preforms in stable positions during handling.

13. A device as claimed in claim 13, characterized in that said means include suction systems that operate through suitable perforations (20) of the conveyor device at the preform deposit area.

14. A device as claimed in claim 13, characterized in that said means include inverter motors which are calibrated in such a manner as to ensure low acceleration or deceleration values for the conveyor device.

15. A device as claimed in claim 13, characterized in that said means include mounting pins (30) that extend vertically from the conveyor device, in or on their respective preforms (3).

16. A device as claimed in claim 13, characterized in that said conveyor device is at least one belt conveyor.

17. A device as claimed in claim 15, characterized in that said pins (30) are either fixed or vertically retractable under the conveyor device.

18. A device as claimed in claim 15, characterized in that said pins (30) are driven by further drive means, other than the preform conveyor device, for preform accumulation.

19. A device as claimed in claim 9, characterized in that said ejection means (MS) include a plurality of bushings or cylinders, each adapted to receive a preform (3); by actuating vacuum, the ejection means (MS) hold the preforms (3) thereon and can take a vertical position to release them to the underlying head (1) which transfers them to the conveyor device (2).
